(19) United States
(12) Patent Application Publication
(10) Pub. No.: US 2025/0381777 A1
(43) Pub. Date: Dec. 18, 2025

(54) PRINT HEAD EQUIPPED WITH CONTAMINATION DETECTION DEVICE AND CONTAMINATION DETECTION DEVICE

(71) Applicant: KISHU GIKEN KOGYO CO., LTD., Wakayama (JP)

(72) Inventor: Koji Kasano, Wakayama (JP)

(21) Appl. No.: 19/217,586

(22) Filed: May 23, 2025

(30) Foreign Application Priority Data
Jun. 14, 2024 (JP) 2024-096416

(51) Int. Cl. B41J 2/125; B41J 2/02; B41J 2/045; B41J 2/085; B41J 2/09; B41J 2/18; B41J 2/185

(52) U.S. Cl. CPC B41J 2/125; B41J 2/02; B41J 2/0451; B41J 2/085; B41J 2/09; B41J 2/18; B41J 2002/022; B41J 2/04586; B41J 2002/1853

(57) ABSTRACT

A print head equipped with a contamination detection device detects ink contamination of a print head of a continuous-type inkjet printer and includes a print head that includes a nozzle that ejects ink droplets, charging electrodes that charge the ink droplets, deflection electrodes that deflect the charged ink droplets with an electric field, and a gutter that collects the ink droplets that are not used for printing, and a contamination detection device that includes a camera that images at least a part of a flight region where the ink droplets ejected from the nozzle fly from a side in a direction in which the ink droplets are ejected from the nozzle or in a direction in which the deflection electrodes face each other, and an information processing unit that performs processing of image data captured by the camera.

### FIELD

The present invention relates to a print head including a device that detects contamination of an inkjet printer, and particularly to a print head equipped with a contamination detection device that detects contamination of a head of an inkjet printer by a camera capturing an image.

### BACKGROUND

Inkjet printers (hereinafter, abbreviated as “IJPs”) are roughly categorized into a continuous type and an on-demand type. Among these, IJPs of the continuous type are adapted such that ink is ejected from a nozzle by a pump and ink droplets are charged by charging electrodes at a position where the ejected ink is separated into the ink droplets and are caused to land at predetermined positions on a printed surface with trajectories of the ink droplets bent by deflection electrodes to thereby form printed dots.

If printing is repeated by the IJPs of the continuous type as described above, ink contamination adheres to the inside of the print head, such as surfaces of the deflection electrodes and a gutter.

If such a state is left, it may lead to a printing failure, and it is thus necessary to remove the adhering ink and the like by regularly cleaning the inside of the print head.

Although Japanese Patent Laid-Open No. 2019-171651 discloses a cleaning device for a print head, it is necessary for an operator to check whether or not there is contamination by removing a cover of the print head.

Thus, International Publication No. WO 2015/187926 proposes a system that determines whether ink has been accumulated on an inner surface of a print head by measuring a level of a decrease in laser light blocked by contamination using an optical sensor.

However, since the system of International Publication No. WO 2015/187926 uses the laser light, it is necessary to emit a large number of laser light beams only to detect contamination at a gutter portion, and there is a problem that it is difficult to detect contamination of components other than the gutter.

The present invention has been made in view of the aforementioned problem, and an object thereof is to provide a contamination detection device capable of detecting contamination of portions other than a gutter, such as charging electrodes and deflection electrodes.

### SUMMARY

The invention that has been made to solve the above problem is a print head equipped with a contamination detection device that detects ink contamination of a print head of a continuous-type inkjet printer, comprising:

a print head that includes a nozzle that ejects ink droplets, charging electrodes that charge the ink droplets, deflection electrodes that deflect the charged ink droplets with an electric field, and a gutter that collects the ink droplets that are not used for printing; and

a contamination detection device that includes a camera that captures images from a side in a direction in which the ink droplets are ejected from the nozzle and from a side in a direction in which the deflection electrodes face each other and an information processing unit that performs processing of image data captured by the camera, the information processing unit including a storage unit that stores the image data along with an imaging date and time and a detection unit that regards a part or entirety of a region imaged by the camera as a contamination detection target region where the information processing unit is to detect contamination, compares the contamination detection target region in two pieces of image data captured at different imaging dates and times, creates difference image data that identifies different parts between the two pieces of image data, and detects ink contamination from the difference image data.

Thus, the camera images ink contamination in this manner, and it is thus possible to detect contamination in a wider range on the print head than in a case where the ink contamination is detected using laser light. In addition, since the camera captures images from the side in the direction in which the ink droplets are ejected from the nozzle and from the side in the direction in which the deflection electrodes face each other, it is possible to image contamination between the deflection electrodes as well.

Further, the print head equipped with a detection device according to the present invention includes an information processing unit that performs processing of image data captured by the camera, and the information processing unit preferably includes a storage unit that stores the image data along with an imaging date and time and a detection unit that regards a part or entirety of a region imaged by the camera as a contamination detection target region where the information processing unit is to detect contamination, compares the contamination detection target region in two pieces of image data captured at different imaging dates and times, creates difference image data that identifies different parts between the two pieces of image data, and detects ink contamination from the difference image data. It is thus possible to automatically detect head contamination.

The camera preferably images at least a part of a flight region where the ink droplets ejected from the nozzle fly. If ink contamination enters the flight region of the ink droplets, the ink contamination prevents the ink droplets from flying, and a printing failure suddenly occurs. Since it is possible to detect that the ink contamination has entered the flight region by imaging the flight region, it is possible to prevent a printing failure by stopping printing and cleaning the nozzle or the like.

The print head equipped with a detection device according to the present invention preferably includes an output device that outputs image data captured by the camera as images. It is thus possible for a person to view the images displayed on the output device such as a monitor or a printer and to check a level of contamination of the print head.

The print head preferably includes a prediction unit that calculates a speed at which the ink contamination grows in a predetermined or predicted contamination growth direction using at least one piece of difference image data in a case where the detection unit detects the ink contamination, and predicts a date and time when the ink contamination will reach a flight region from a distance between the ink contamination detected in the difference image data and the flight region in the contamination growth direction. It is thus possible to predict a date when a printing failure will occur due to the contamination.

In the print head equipped with a contamination detection device according to the present invention, the storage unit preferably stores the date and time when the ink contamination will reach the flight region, and the prediction unit preferably predicts a date and time before the date and time when the ink contamination will reach the flight region as a date and time when the print head is to be cleaned. It is thus possible to perform cleaning before a printing failure occurs and to reduce a printing failure due to ink contamination.

The contamination detection target region preferably includes a most frequently contaminated region which is a region including at least one of a space between a positive deflection electrode and the flight region or a space which is a space inside the flight region and is adjacent to an entrance of the gutter. It is thus possible to reduce errors in setting a cleaning timing since an important region for detecting head contamination is included in the contamination detection target region.

The print head equipped with a detection device according to the present invention preferably includes a head cover that covers the print head, and the camera is preferably attached to outside of the head cover and images inside of the head cover via an inspection window provided in the head cover. There is thus an advantage that head contamination is unlikely to adhere to the camera.

The present invention includes a contamination detection device that detects ink contamination of a print head of a continuous-type inkjet printer, the print head including a nozzle that ejects ink droplets, charging electrodes that charge the ink droplets, deflection electrodes that deflect the charged ink droplets with an electric field, and a gutter that collects the ink droplets that are not used for printing, the contamination detection device including a camera that captures images from a side in a direction in which the ink droplets are ejected from the nozzle and from a side in a direction in which the deflection electrodes face each other.

As described above, the print head equipped with the detection device according to the present invention can detect contamination of the head in a wide range with a simple device.

### BRIEF DESCRIPTION OF THE DRAWINGS

FIGS. 1(a) and 1(b) are a front view and a side view schematically illustrating a configuration of a print head according to a first embodiment of the present invention;

FIG. 2 is a schematic front view displaying a flight region of the print head illustrated in FIGS. 1(a) and 1(b);

FIG. 3 is a schematic front view displaying a contamination detection target region and a most frequently contaminated region of the print head illustrated in FIGS. 1(a) and 1(b);

FIG. 4 is a functional block diagram of an information processing unit according to the first embodiment;

FIG. 5 is an image database that is stored by a storage unit of the information processing unit according to the first embodiment;

FIG. 6 is a display example of a display according to the first embodiment;

FIGS. 7(a) to 7(c) are examples illustrating how contamination detected by difference image data enters the flight region with time;

FIG. 8 is an explanatory diagram illustrating a method of predicting a date and time when head contamination reaches the flight region; and

FIG. 9 is an explanatory diagram illustrating another method of predicting a date and time when head contamination reaches the flight region.

### DETAILED DESCRIPTION

Hereinafter, an embodiment of the present invention will be described in detail with reference to the drawings as needed. However, the present invention is not limited to the following embodiment, and various modifications can be appropriately made without departing from the gist of the present invention.

### First Embodiment

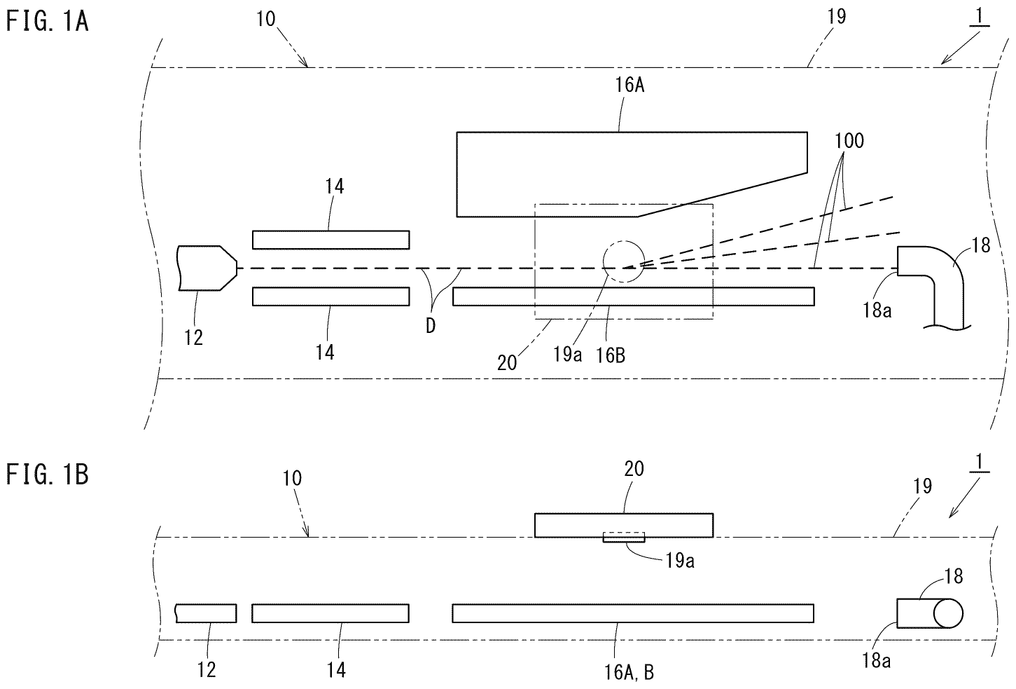

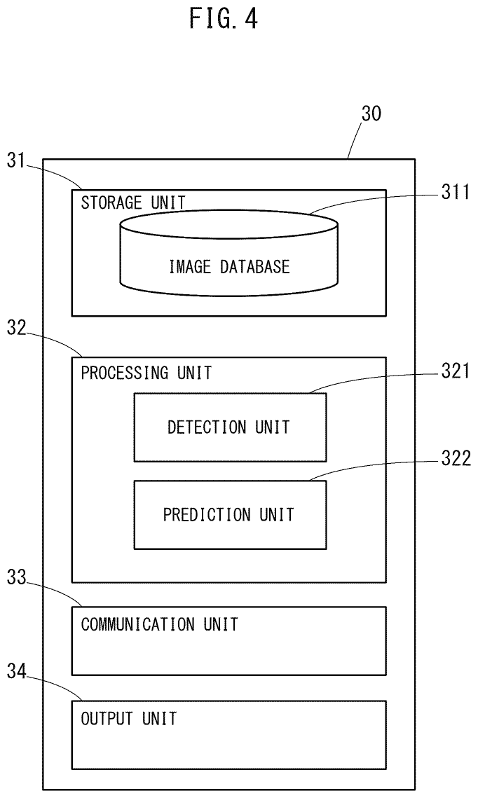

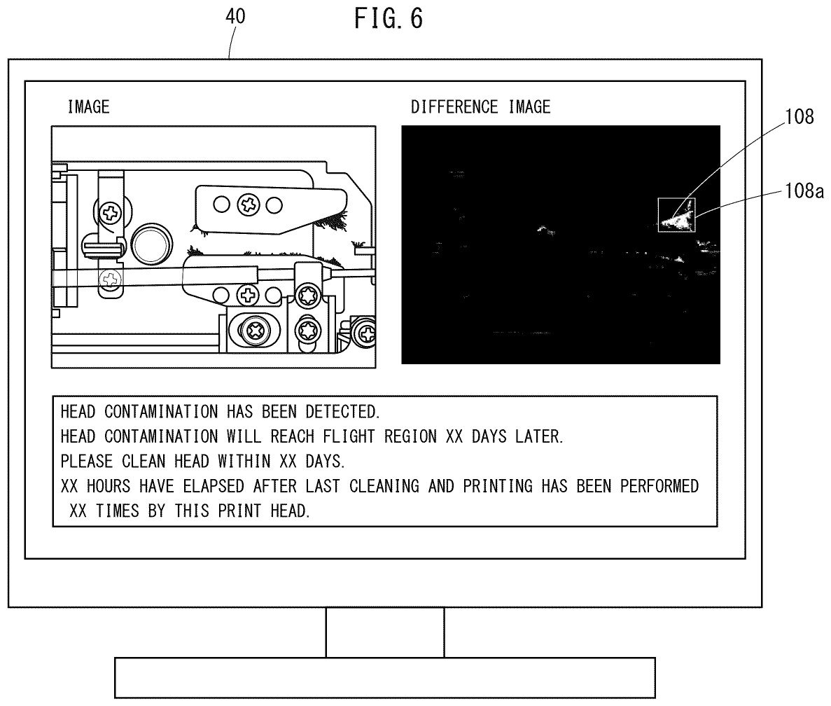

A print head equipped with a contamination detection device 1 according to a first embodiment of the present invention will be described using FIGS. 1(a) to 7(c). The print head equipped with a contamination detection device 1 mainly includes a print head 10 and a camera 20 (see FIG. 1(b)) as illustrated in FIGS. 1(a) and 1(b), and also includes an information processing unit 30 (see FIG. 4) and a display (output device) 40 (see FIG. 6).

The print head 10 includes a nozzle 12 that ejects ink droplets D, charging electrodes 14 that negatively charge the ink droplets, deflection electrodes 16 that deflect the charged ink droplets with an electric field, a gutter 18 that collects the ink droplets that are not used for printing, and a head cover 19 as illustrated in FIGS. 1(a) and 1(b). The deflection electrodes 16 form the electric field with a positive deflection electrode 16A and a negative deflection electrode 16B facing each other with the flying ink droplets sandwiched therebetween. The reference sign 18a denotes an entrance of the gutter 18.

The nozzle 12 ejects ink fed from an ink tank by a pump and vibrated by an ultrasonic vibrator (none of the pump, the ink tank, and the ultrasonic vibrator is illustrated). The ink droplets ejected from the nozzle 12 are negatively charged by a positive pulse voltage applied to the a 14, and some of the ink droplets that are to be used for printing are then deflected to routes on the side of the positive deflection electrode 16A toward positions where printing is to be performed with the electric field formed by the deflection electrodes 16, while the other ink droplets that are not used for printing fly and are then collected by the gutter 18 after advancing straight.

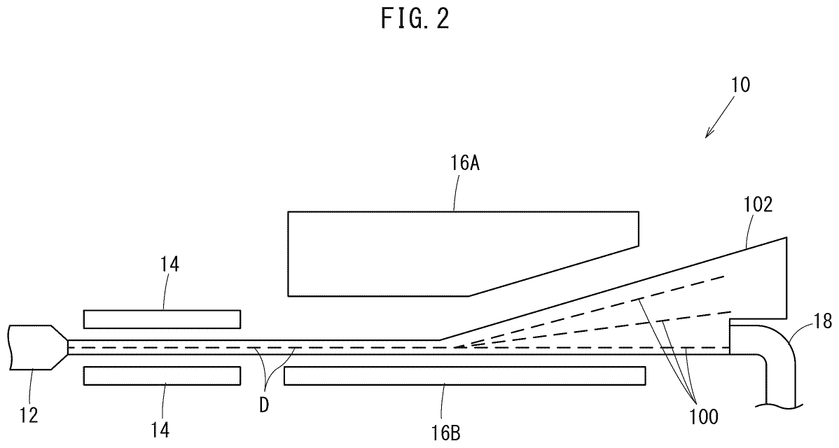

The routes along which the ink droplets fly will be referred to as flight routes 100 (illustrated by the dotted lines in FIG. 2). The flight routes 100 cover a range where printing is to be performed, a different number of flight routes 100 are provided for each position where printing is to be performed, and a region formed by the multiple flight routes 100 will be referred to as a flight region 102 (displayed by the closed figure of the solid line in FIG. 2).

The camera 20 is a digital camera including an image sensor such as a CCD or a CMOS, for example, and includes an LED light to illuminate the inside of the head cover 19. The camera 20 is provided outside the head cover 19 as illustrated in FIG. 1(b) and images the inside of the head cover 19 via an inspection window 19a in the head cover 19. There is an advantage that the camera 20 is not contaminated by the ink droplets by providing the camera 20 outside the head cover 19. However, the camera 20 may be provided inside the head cover 19.

In addition, a wide angle lens or a fisheye lens may be attached to the inspection window 19a. It is thus possible to image a sufficiently wide range even in a case where the distance between the lens and an object is short.

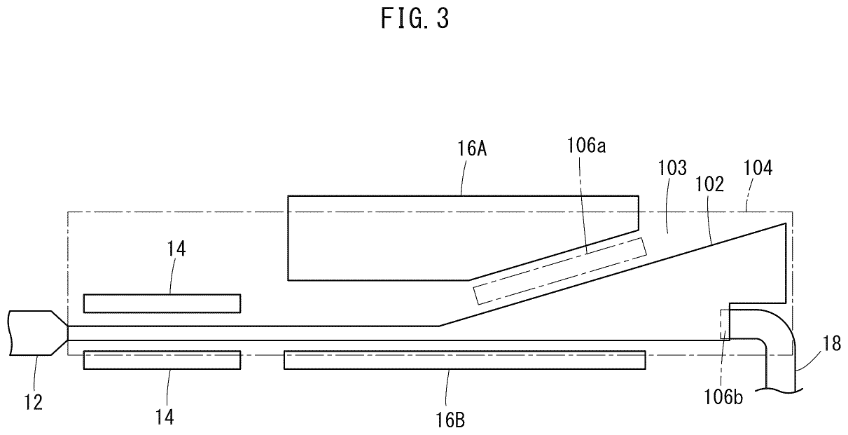

The camera 20 captures images from a side in a direction in which the ink droplets D are ejected from the nozzle 12 (the rightward direction in FIG. 1(a)) and from a side in a direction in which the deflection electrodes face each other (the up-down direction in FIG. 1(a)) as illustrated in FIGS. 1(a) and 1(b). The camera 20 images a region including a contamination detection target region 104 which is a target of contamination detection by the information processing unit 30 as illustrated in FIG. 3. The contamination detection target region 104 is a part or entirety of the region imaged by the camera 20 and is a region including an entirety or part of a peripheral region 103 of the flight region 102 which is a space between the nozzle 12 and the gutter 18, a space between the charging electrodes 14, and a space between the deflection electrodes 16.

In the first embodiment, the contamination detection target region 104 (the region indicated by the one-dotted chain line in FIG. 3) is a rectangular region including the space between the nozzle 12 and the gutter 18, the space between the charging electrode 14, and the space between the pair of the positive deflection electrode 16A and the negative deflection electrode 16B and includes the entire flight region 102 and the peripheral region 103 thereof as illustrated in FIG. 3. The contamination detection target region 104 also includes a most frequently contaminated region 106 where contamination is particularly likely to occur. The most frequently contaminated region 106 includes a first most frequently contaminated region 106a including the space between the positive deflection electrode 16A and the flight region 102 and a second most frequently contaminated region 106b that is included in the flight region 102 and is adjacent to the entrance of the gutter 18.

If ink contamination occurs in the flight region 102, flight of the ink droplets is prevented by the ink contamination, and a hindrance immediately occurs in printing. It is possible to address sudden occurrence of a printing failure by the contamination detection target region 104 including the flight region 102 in this manner.

In addition, it is possible to detect contamination that may affect printing in the future in advance by the contamination detection target region 104 including the peripheral region 103. It is possible to reduce missing of contamination that has occurred in the print head 10 by the contamination detection target region 104 including the most frequently contaminated region 106 where ink contamination quickly grows, particularly, the first most frequently contaminated region 106a where ink contamination quickly grows, as compared with a case where the region is not included. However, the contamination detection target region 104 may include only a part of the flight region 102, may include only a part of the peripheral region 103, and may not include the most frequently contaminated region 106.

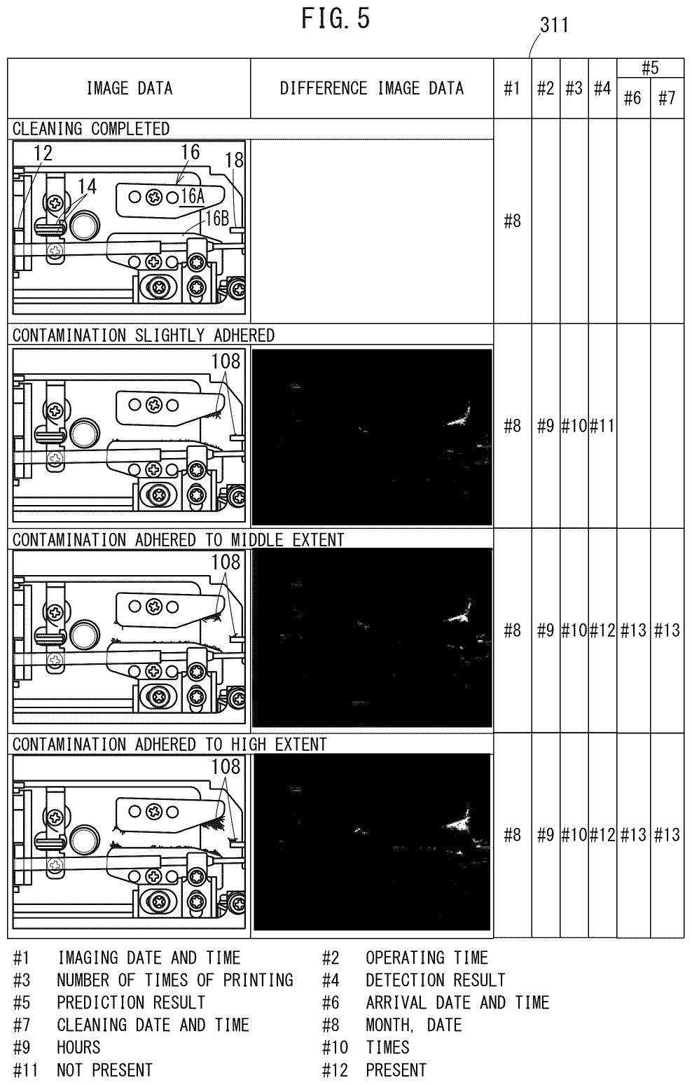

The information processing unit 30 is configured of a storage unit 31, a processing unit 32, a communication unit 33, and an output unit 34 as illustrated in FIG. 4. The storage unit 31 stores image data obtained by the camera 20 imaging the inside of the head and an image database (see FIG. 5) that includes an imaging date and time and the like together and also includes data that specifies the flight region 102, the contamination detection target region 104, and the most frequently contaminated region 106 described above.

The processing unit 32 is configured of a detection unit 321 and a prediction unit 322.

The detection unit 321 performs head contamination detection processing, and the prediction unit 322 predicts a date and time when the head contamination will reach the flight region 102 and a date and time when the head is to be cleaned.

The detection unit 321 compares the contamination detection target region 104 in a plurality of pieces of image data captured at different dates and times, creates difference image data that identifies different parts in the image data, and detects ink contamination from the difference image data. The detection unit 321 can thus automatically detect head contamination on the basis of the difference image data.

How the detection unit 321 works will be specifically described with reference to an image database 311 (illustrated in FIG. 5) stored in the storage unit 31. The image database 311 is a database for managing image data and is configured of image data, difference image data, imaging dates and times, operating times, the numbers of times of printing, and the like. In an example, the storage unit 31 stores image data in each of a state where cleaning has been completed, a state where contamination has slightly adhered, a state where contamination has adhered to a middle extent, and a state where contamination has adhered to a high extent. The state where the cleaning has been completed is a state after cleaning of head contamination.

The output unit 34 outputs the image data as an image and the difference image data as a difference image to the display 40 and also outputs an operating time, the number of times of printing, a detection result, predicted dates and times.

The detection unit 321 compares image data in the state where the cleaning has been completed and image data in the state where contamination has slightly adhered and creates data (difference image data) to display parts included in both by a black color and parts that are included in the latter and are not included in the former by a white color. The difference image data is displayed as a difference image on the display 40 (see FIG. 6).

The detection unit 321 extracts a region of head contamination (hereinafter, referred to as a contaminated portion 108) from the difference image data. The detection unit 321 preferably extracts only a region that is larger than a predetermined area in the contaminated portion 108 as the contaminated portion 108. This is for preventing noise in the images from being erroneously recognized as the contaminated portion 108. Moreover, it is possible to predict a more appropriate date and time by predicting the date and time when head contamination reaches the flight region 102, which will be described later, by targeting large head contamination instead of small head contamination. Furthermore, the detection unit 321 preferably creates a frame of a rectangle, a polygonal, or a circle that surrounds the outer shape of the contaminated portion 108. In this manner, an operator can easily recognize the outer shape of the contaminated portion 108 (see FIG. 6).

The prediction unit 322 predicts a date and time when the contaminated portion 108 will reach the flight region 102 (hereinafter, referred to as a head contamination arrival date and time) in a case where the detection unit 321 extracts the contaminated portion 108. The prediction unit 322 calculates a speed at which the contaminated portion 108 grows in a predetermined contamination growth direction 11 using at least one piece of difference image data and predicts a date and time when the contaminated portion 108 will reach the flight region 102 from the distance between the contaminated portion 108 extracted in the difference image data and the flight region 102 in the contamination growth direction 11. In this manner, the operator can check not only the extraction result of the contaminated portion 108 but also the predicted dates and times when the contaminated portion 108 will reach the flight region 102.

The contamination growth direction 11 is stored in the storage unit 31 in advance. The storage unit 31 may store a plurality of contamination growth directions 11. In this manner, it is possible to compare the plurality of contamination growth direction 11, to apply a contamination growth direction 11 in which the contamination advances at the highest speed, and to thereby more accurately predict the date on which the contaminated portion 108 will enter the flight region 102.

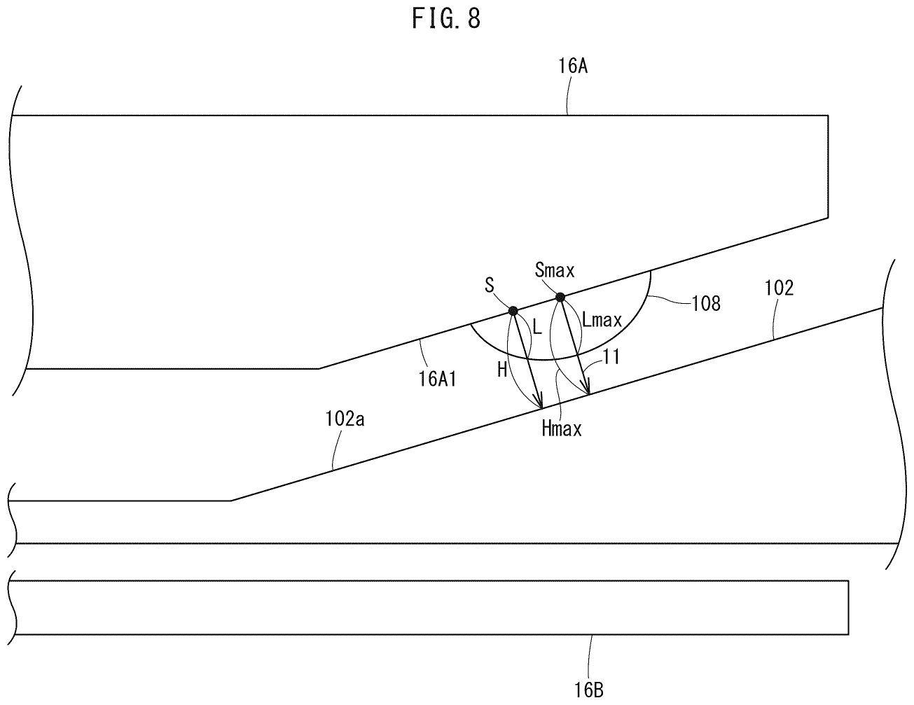

FIG. 8 is a diagram schematically illustrating the contamination growth direction 11, the contaminated portion 108, and the flight region 102. In FIG. 8, the contaminated portion 108 adheres to an inclined portion 16A1 provided to be substantially parallel to an end side 102a of the flight region 102 on the side of the positive deflection electrode 16A at an inner distal end of the positive deflection electrode 16A.

First, the prediction unit 322 temporarily determines a point S on a boundary between the contaminated portion 108 and the inclined portion 16A1. Then, the prediction unit 322 calculates a length L inside the contaminated portion 108 from the point S in the contamination growth direction 11 stored in advance in the storage unit 31. The prediction unit 322 repeats the calculation while successively moving the point S over the entire length of the boundary between the inside of the contaminated portion 108 and the inclined portion 16A1 and obtains a point Smax at which the length L has a maximum value Lmax during the movement. Next, the prediction unit 322 calculates a distance Hmax from the point Smax to the flight region 102. The prediction unit 322 calculates a speed at which the head contamination grows in the contamination growth direction 11 from the length Lmax and the operating time. Then, the prediction unit 322 calculates a head contamination arrival date and time from the distance Hmax and the speed at which the head contamination grows.

Next, a method of predicting the contamination growth direction 11 and then predicting a head contamination arrival date and time in a case where the contamination growth direction 11 is not stored in advance in the storage unit 31 will be described.

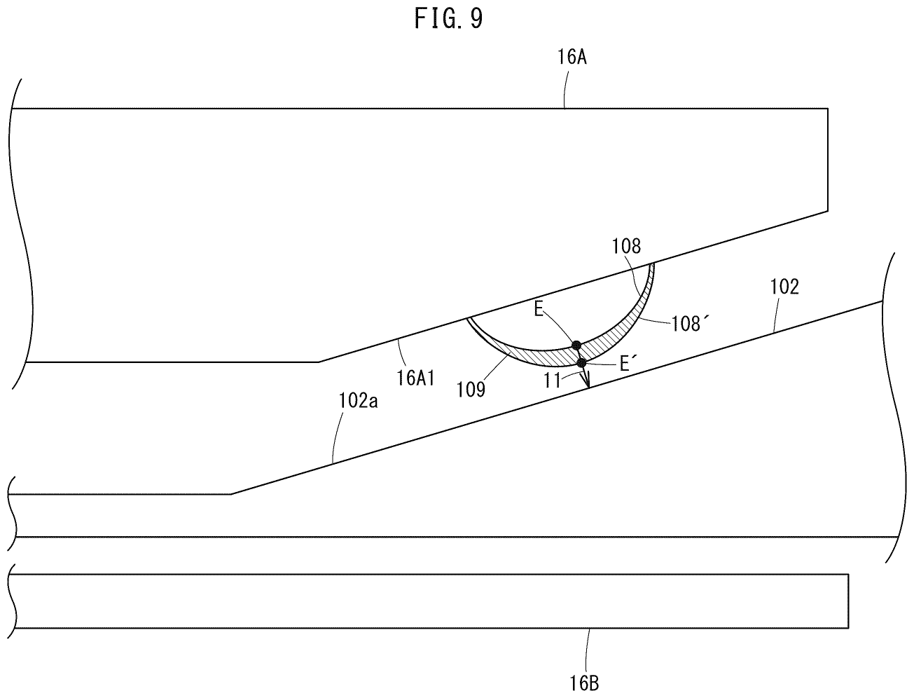

FIG. 9 is a diagram schematically displaying a contaminated portion 108 in a state where contamination has slightly adhered and a contaminated portion 108′ in a state where contamination has adhered to a middle extent, which are extracted by the detection unit 321. First, the prediction unit 322 finds a maximum contamination adhesion point E (a point separated from the positive deflection electrode 16A with the longest distance) in the contaminated portion 108 in order to estimate the contamination growth direction 11. The prediction unit 322 finds a maximum contamination adhesion point E′ in the contaminated portion 108′. Then, the prediction unit 322 predicts a direction connecting the point E and the point E′ as the contamination growth direction 11. Processing after the contamination growth direction 11 is predicted is similar to the processing method described above.

The method by which the prediction unit 322 predicts the contamination growth direction 11 is not limited thereto. For example, the prediction unit 322 creates a difference between image data in a state where contamination has slightly adhered and image data in a state where contamination has adhered to a middle extent. The difference image data indicates head contamination that has adhered from the former image data and the latter image data, that is, a region where the head contamination has grown in a predetermined period of time (the hatched portion in FIG. 9) and will be referred to as a contamination growth portion 109. The prediction unit 322 can predict the direction directed from the inclined portion 16A1 to the flight region 102 and connecting the two points at the widest width in the contamination growth portion 109 as the contamination growth direction 11.

As described above, the operator can recognize not only whether or not there is head contamination but also a timing when a printing failure will occur due to the head contamination by the prediction unit 322 predicting the head contamination arrival date and time.

The prediction unit 322 predicts a date and time before the head contamination arrival date and time as a date and time when the print head 10 is to be cleaned (hereinafter, referred to as a cleaning date and time). Specifically, the prediction unit 322 sets the cleaning date and time a predetermined period of time before the head contamination arrival date and time. The predetermined period of time may be a fixed time (two days, for example), or the predetermined period of time is calculated in consideration of an operation status of the print head 10 and a period of time necessary for the cleaning. In this manner, the operator can recognize not only the head contamination arrival date and time but also the cleaning date and time, and the print head can be automatically cleaned before the contamination reaches the flight region 102.

The communication unit 33 performs communication with the camera 20, communication with the display 40, and communication with a production management system (not illustrated).

The output unit 34 outputs image data as an image and difference image data as a difference image to the display 40 and also outputs an operating time, the number of times of printing, a detection result, and predicted dates and times as illustrated in FIG. 6. The detection result means whether or not there is head contamination, and the predicted dates and times mean the head contamination arrival date and time and the cleaning date and time. The output unit 34 preferably outputs the flight region 102, the most frequently contaminated region 106, the contaminated portion 108, and a rectangle or the like that surrounds the outer shape of the contaminated portion 108. In this manner, the operator can check the contaminated portion 108 extracted by the detection unit 321 without missing and can recognize a positional relationship between the contaminated portion 108 and the flight region 102 or the most frequently contaminated region 106.

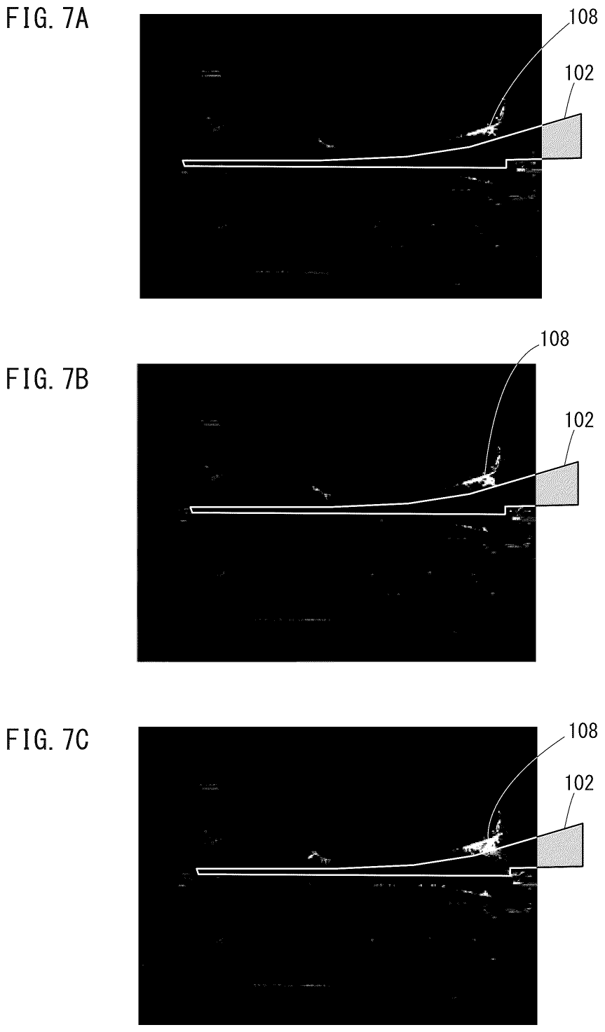

FIGS. 7(a) to 7(c) are conceptual diagrams illustrating difference images and the flight region 102 in a superimposed manner. FIGS. 7(a), 7(b), and 7(c) illustrate a difference image in a state where contamination has slightly adhered, a difference image in a state where contamination has adhered to a middle extent, and a difference image in a state where contamination has adhered to a high extent. The output unit 34 preferably outputs the difference images in the state where contamination has adhered in the order of the imaging dates and times. It is thus possible to ascertain that the contaminated portion 108 has been growing and approaching the flight region 102.

Since the ink droplets ejected from the nozzle 12 fly along different flight routes 10 depending on the sizes of letters to be printed, the detection unit 321 and the prediction unit 322 may use different flight regions 102 for each letter size. It is thus possible to detect head contamination and predict the head contamination arrival date and time and the cleaning date and time with higher accuracy in accordance with the sizes of the letters to be printed.

As described above, the present invention is not limited to the aforementioned embodiment. For example, the camera 20 may not image the flight region where the ink droplets ejected from the nozzle fly and may be attached to the inside of the head cover 19. The print head 10 may not include the head cover 19. The print head equipped with a contamination detection device 1 may not include the output device that outputs image date captured by the camera. The contamination detection target region where contamination is to be detected may not include the most frequently contaminated region that is a region including at least one of the space between the positive deflection electrode 16A and the flight region 102 and the space that is a space inside the flight region 102 and is adjacent to the entrance of the gutter 18.

What is claimed is:

1. A print head equipped with a contamination detection device that detects ink contamination of a print head of a continuous-type inkjet printer, comprising:
a print head comprising a nozzle configured to eject ink droplets, charging electrodes configured to charge the ink droplets, deflection electrodes configured to deflect the charged ink droplets with an electric field, and a gutter configured to collect the ink droplets that are not used for printing; and
a contamination detection device comprising a camera configured to capture images from a side in a direction in which the ink droplets are ejected from the nozzle and from a further side in a direction in which the deflection electrodes face each other, the contamination detection device further comprising an information processing unit configured to perform processing of data associated with the images captured by the camera, the information processing unit comprising a storage unit configured to store the image data along with an imaging date and time associated with that image data, the information processing unit further comprising a detection unit configured to regard at least one of a part and an entirety of a region imaged by the camera as a contamination detection target region where the information processing unit is to detect contamination, the detection unit further configured to compare the contamination detection target region in two pieces of the image data associated with the images captured at different imaging dates and times, create difference image data that identifies different parts between the two pieces of image data, and detect ink contamination from the difference image data.

2. A print head equipped with a contamination detection device according to claim 1, wherein the camera is configured to image at least a part of a flight region where the ink droplets ejected from the nozzle fly.

3. A print head equipped with a contamination detection device according to claim 1, further comprising:
an output device configured to output the images captured by the camera.

4. A print head equipped with a contamination detection device according to claim 2, further comprising:
a prediction unit configured to calculate a speed at which the ink contamination grows in a predetermined or predicted contamination growth 4 direction using at least one piece of the difference image data when the detection unit detects the ink contamination, the prediction unit further configured to predict a date and time when the ink contamination will reach the flight region using the speed and a distance in the contamination growth direction between the ink contamination detected in the at least one piece of the difference image data and the flight region.

5. A print head equipped with a contamination detection device according to claim 4, wherein:
the storage unit is further configured to store the date and time when the ink contamination will reach the flight region; and
the prediction unit is further configured to predict a date and time before the date and time when the ink contamination will reach the flight region as a date and time when the print head is to be cleaned.

6. A print head equipped with a contamination detection device according to claim 2, wherein the contamination detection target region comprises a most frequently contaminated region, the most frequently contaminated region comprising at least one of:
a space between a positive one of the deflection electrodes and the flight region; and
a space inside the flight region that is adjacent to an entrance of the gutter.

7. A print head equipped with a contamination detection device according to claim 1, comprising:
a head cover that covers the print head, wherein
the camera is attached to outside of the head cover and is further configured to image inside of the head cover via an inspection window provided in the head cover.

8. A contamination detection device that detects ink contamination of a print head equipped with a print head of a continuous-type inkjet printer, comprising:
a contamination detection device configured to detect ink contamination of a print head of a continuous-type inkjet printer that comprises a nozzle configured to eject ink droplets, charging electrodes configured to charge the ink droplets, deflection electrodes configured to deflect the charged ink droplets with an electric field, and a gutter configured to collect the ink droplets that are not used for printing, the contamination detection device comprising:
a camera configured to capture images from a side in a direction in which the ink droplets are ejected from the nozzle and from a further side in a direction in which the deflection electrodes face each other; and
an information processing unit configured to perform processing of data associated with the images captured by the camera, the information processing unit comprising a storage unit configured to store the image data along with an imaging date and time associated with that image data, the information processing unit further comprising a detection unit configured to regard at least one of a part and an entirety of a region imaged by the camera as a contamination detection target region where the information processing unit is to detect contamination, the detection unit further configured to compare the contamination detection target region in two pieces of the image data associated with the images captured at different imaging dates and times, create difference image data that identifies different parts between the two pieces of image data, and detect ink contamination from the difference image data.
